(19) United States
(12) Patent Application Publication
(10) Pub. No.: US 2013/0054379 A1
(43) Pub. Date: Feb. 28, 2013

(54) SYSTEM AND METHOD FOR SELECTIVELY PROVIDING ADVERTISEMENT

(71) Applicants: Mun Deock SEO, Seoul (KR); Tae Gun Kim, Seoul (KR)

(72) Inventors: Mun Deock SEO, Seoul (KR); Tae Gun Kim, Seoul (KR)

(73) Assignee: PANTECH CO., LTD., Seoul (KR)

(21) Appl. No.: 13/598,455

(22) Filed: Aug. 29, 2012

(30) Foreign Application Priority Data
Aug. 31, 2011 (KR) 10-2011-0087552

(51) Int. Cl. G06Q 30/02

(52) U.S. Cl. 705/14.69; 705/14.4

(57) ABSTRACT

An advertising system includes a first terminal to transmit an advertisement receipt consent signal; and an advertising server to store a list of advertisements, to provide one or more advertisements from the list of advertisements to be selected, and to provide a selected advertisement to the first terminal. A method for selectively providing an advertisement includes transmitting an advertisement receipt consent signal from a first terminal; selecting an advertisement from a list of advertisements; and providing the selected advertisement to the first terminal.

### CROSS-REFERENCE TO RELATED APPLICATION

This application claims priority to and the benefit of Korean Patent Application No. 10-2011-0087552, filed on Aug. 31, 2011, the entire content of which is incorporated herein by reference.

### BACKGROUND

1. Field

The following description relates to an advertising system, which can selectively display an advertisement through a terminal.

2. Discussion of the Background

Mobile terminals, such as cellular phones, may be in widespread use, and users may carry cellular phones with them in many everyday situations. Therefore, advertising is exposure can be increased by transmitting advertising information to cellular phones, which may allow users to gain access to the advertising information more frequently. However, by transmitting advertisements to the users' mobile terminals that may not be pertinent to the users' characteristics (e.g., interests, age, sex, etc.) may have an adverse effect to what may be intended by the advertisement and leave the users vulnerable to bombardment of unwanted advertisement. Accordingly, the users may ignore the received advertisements without review.

The above information disclosed in this Background section is provided for enhancement of understanding of the background of the invention and therefore it may contain information that does not form any part of the prior art nor what the prior art may suggest to a person of ordinary skill in the art.

### SUMMARY

Exemplary embodiments of the present invention provide an advertising system to selectively receive an advertisement through a terminal.

Additional features of the invention will be set forth in the description which follows, and in part will be apparent from the description, or may be learned by practice of the invention.

Exemplary embodiments of the present invention provide an advertising system including a first terminal to transmit an advertisement receipt consent signal; and an advertising server to store a list of advertisements, to provide one or more advertisements from the list of advertisements to be selected, and to provide a selected advertisement to the first terminal.

Exemplary embodiments of the present invention provide a method for selectively providing an advertisement including transmitting an advertisement receipt consent signal from a is first terminal; selecting an advertisement from a list of advertisements; and providing the selected advertisement to the first terminal.

Exemplary embodiments of the present invention provide an advertising system including a first terminal to transmit a first advertisement receipt consent signal; an advertising server to store a list of advertisements selectable by the first terminal, to associate a selected advertisement with the first terminal, and to provide the selected advertisement to the first terminal; a communication server to transmit an inquiry to a second terminal inquiring whether to display the selected advertisement on the second terminal; and the second terminal to receive the selected advertisement if the second terminal transmits a consent control signal in response to the inquiry.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a schematic diagram of an advertising system according to an exemplary embodiment of the present invention.

FIG. 2 is a flowchart illustrating operations of the advertising system of FIG. 1.

FIG. 3 is a diagram illustrating an advertisement selection screen in the advertising system of FIG. 1.

FIG. 4 is a diagram illustrating an advertisement displayed on a transmitter terminal in the advertising system of FIG. 1.

FIG. 5A and FIG. 5B illustrate an advertisement displayed on a receiver terminal in an advertising system according to an exemplary embodiment of the present invention.

FIG. 6 illustrates an advertisement displayed on a receiver terminal during a video call in the advertising system of FIG. 5A.

FIG. 7 illustrates an advertisement displayed on a receiver terminal in response to a text message received in an advertising system according to an exemplary embodiment of the present invention.

FIG. 8 illustrates that an advertisement displayed in response to execution of a text message transmitting application in an advertising system according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. Throughout the drawings and the detailed description, unless otherwise described, the same drawing reference numerals are understood to refer to the same elements, features, and structures. The relative size and depiction of these elements may be exaggerated for clarity.

It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). It will be further understood that when an element is referred to as being “on” or “connected to” another element, it can be directly on, or directly connected to the other element, or intervening elements may be present. In contrast, if an element is referred to as being “directly on” or “directly connected to” another element, no intervening elements are present.

A configuration of an advertising system using a mobile terminal according to an exemplary embodiment of the present invention will now be described.

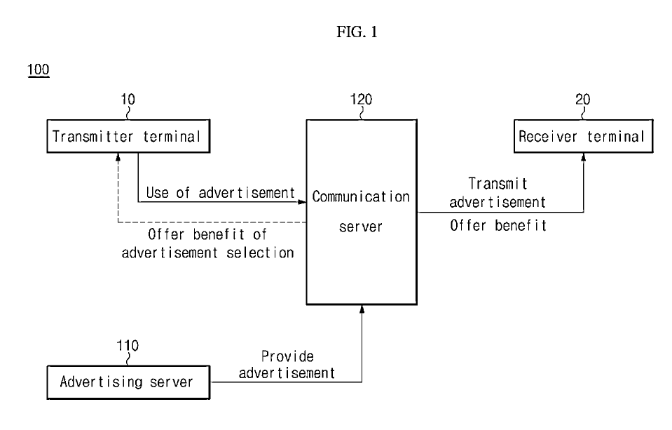

FIG. 1 is a schematic diagram of an advertising system according to an exemplary embodiment of the present invention.

Referring to FIG. 1, an advertising system 100 includes a transmitter terminal 10, a receiver terminal 20, an advertising server 110 and a communication server 120.

The advertising server 110 is connected to the communication server 120. If the transmitter terminal 10 transmits an advertisement receipt consent signal through the communication server 120, the advertising server 110 may provide the transmitter terminal 10 with a list of advertisements to allow the transmitter terminal 10 to select a desired advertisement.

In addition, a user of the transmitter terminal 10 may connect to a web site operated by the advertising server 110 using a computer or a similar device. In this case, the user of the transmitter terminal 10 may receive the list of advertisements to be selected from the web site and select one or more desired advertisements to be received by the transmitter terminal 10. Here, the advertising server 110 may provide the transmitter terminal 10 with the advertisement selected by the user of the transmitter terminal 10 through the communication server 120.

The advertising server 110 may provide the communication server 120 with an advertisement. In addition, if the transmitter terminal 10 connects to the communication server 120, the advertising server 110 may provide the transmitter terminal 10 with the advertisement. The advertisement may be provided in various forms, including at least one of a company logo, a product trademark, an advertisement capture screen, an advertising motion picture, a dial tone, a ring tone, and the like.

The communication server 120 is connected to the advertising server 110 and may provide the transmitter terminal 10 and the receiver terminal 20 with an advertisement. The advertisement may include an advertisement in the form specified (e.g., a company logo, a product trademark, etc.) by the user of the transmitter terminal 10 through the transmitter terminal 10 or the web site. The transmitter terminal 10 may display the advertisement by, for example, displaying the advertisement on a directory of contacts. In addition, if a call or a message is transmitted from the transmitter terminal 10, the communication server 120 may inquire about consent to display an advertisement on the receiver terminal 20. If the receiver terminal 20 transmits a consent control signal to consent to receive a display of the respective advertisement, the communication server 120 transmits the advertisement to the receiver terminal 20. The advertisement may be in the form specified by the transmitter terminal 10, which will be below described in more detail.

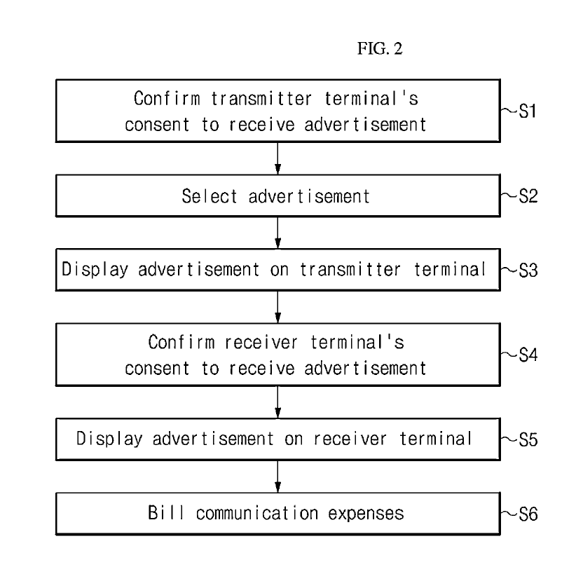

FIG. 2 is a flowchart illustrating a method for selectively receiving advertisement according to an exemplary embodiment of the present invention. The method of FIG. 2 below will be described as if performed by the advertising system as shown in FIG. 1, but is not limited is as such.

Referring to FIG. 2, the method for selectively receiving advertisement includes confirming a transmitter terminal's consent to receive an advertisement (S1), selecting an advertisement (S2), displaying the selected advertisement on the transmitter terminal (S3), confirming receiver terminal's consent to receive the advertisement associated with the transmitter terminal (S4), displaying the advertisement associated with the transmitter terminal on the receiver terminal (S5), and billing (S6).

In the operation of confirming of transmitter terminal's consent (S1), the advertising server 120 may determine or confirm whether the transmitter terminal 10 has consented to receive an advertisement through the communication server 120. The consent of the transmitter terminal 10 may be given using a separate operation window. In a case of a smart phone, the consent of the transmitter terminal 10 may be given using an application program. In addition, a user of the transmitter terminal 10 may connect to the web site linked with the advertising server 120 using a computer, rather than the transmitter terminal 10, to register the transmitter terminal 10 to receive one or more advertisements selected by the user. If the transmitter terminal 10 does not consent to receive one or more advertisement selected by the user, the advertising server 120 may not perform subsequent processes.

In an example, the user may select one or more advertisements corresponding to a particular advertiser, or may select to receive advertisements corresponding to a category of interest, related products, location, and the like, such that the user can check or select the category of interest to receive the advertisement for the selected category (e.g., finance, performance). Further, the user may select to receive advertisement according to a set of criteria (e.g., women's shoes that are on sale for 30% or higher based on the user's location).

In the operation of selecting the advertisement (S2), the advertisement to be displayed on the transmitter terminal 10 may be selected by the user of the transmitter terminal 10. The advertising server 110 may display a list of advertisements on the transmitter terminal 10 to allow the user of the transmitter terminal 10 to select the advertisement. In an example, the advertising server 110 may display the list of advertisements based on user attributes, attributes of the transmitter terminal 10, or without consideration of any specific attribute, but is not limited thereto.

In addition, if the user of the transmitter terminal 10 connects to a web site linked with the advertising server 110 using a computer or a similar device, the advertising server 110 may display a list of advertisements that may be selected to be received on the transmitter terminal 10 on the user's computer. The user of the transmitter terminal 10 may select to receive at least one advertisement from the list of advertisements through the transmitter terminal 10, computer, or other similar devices.

In the operation of displaying the advertisement on the transmitter terminal (S3), the advertisement selected by the transmitter may be displayed on the transmitter terminal 10. The advertisement may be displayed with a directory of contacts in the transmitter terminal 10. For example, an advertisement logo may be displayed next to contact information in the directory of contacts. Therefore, the advertisement may be displayed on a search screen if the user of the transmitter terminal 10 searches for a phone number of a contact from the directory of contacts in the transmitter terminal 10. In addition, the advertisement may be differently set by the user of the transmitter terminal 10 according to each phone number. Further, advertisement associated with the contacts, which may be selected by the respective contacts, may be displayed. Therefore, if the transmitter terminal 10 is used, the advertisement associated with a is contact may be displayed, so that the user of the transmitter terminal 10 may be exposed to the advertisement selected by the contact.

In the operation of confirming receiver terminal's consent to receive the advertisement (S4), if a call or a message is received from the transmitter terminal 10 to the receiver terminal 20, the advertising server 120 may confirm whether the receiver terminal 20 has provided consent to receive the advertisement associated with the transmitter terminal 10.

The advertising server 120 may display a confirmation dialog box on the receiver terminal 20 to allow the receiver terminal 20 to provide consent to display the advertisement associated with at least the transmitting terminal 10. If the receiver terminal 20 provides consent to display the advertisement on the confirmation dialog box, the advertising server 120 may display the advertisement before, during, or after a call with the transmitter terminal 10, or in a message transmitted from the transmitter terminal 10 to the receiver terminal 20 on the receiver terminal 20. Further, the advertising server 120 may display the advertisement of the transmitter terminal 10, if consent is provided by the receiver terminal 20, with call, message, or other notification messages associated with the transmitter terminal 10.

If the receiver terminal 20 opts not to provide consent to display the advertisement from the confirmation dialog box, the advertising server 120 may not display the advertisement of at least the transmitter terminal 10 on the receiver terminal 20.

In addition, if the transmitter terminal 10 additionally transmits another call or message to the receiver terminal 20 later, the advertising server 120 may display or may not display the advertisement according to the previous consent provided by the receiver terminal 20 without inquiring again about consent to display an advertisement on the receiver terminal 20. For example, the receive terminal 20 may be configured to inquire about consent at each time a is call or a message is received from the transmitter terminal 10, or the receiver terminal 20 may be configured to respond according to previously provided consent.

In the operation of displaying of the advertisement on the receiver terminal (S5), if the receiver terminal 20 gives consent to receive the advertisement associated with at least the transmitter terminal 10, the advertisement in the form selected by the transmitter terminal 10 may be displayed on a screen of the receiver terminal 20. The advertisement may be displayed in various forms including, but not limited to, a company logo, a product trademark, an advertisement capture screen, and an advertising motion picture. The receiver terminal 20 may display the advertisement while call waiting is enabled for the transmitter terminal 10, and if a message is transmitted from the transmitter terminal 10, but is not limited thereto. The advertisement may also be displayed on a portion of the message. Description of displaying advertisement will be described more in detail below.

In the billing operation (S6), communication expenses of the transmitter terminal 10 and the receiver terminal 20, which received the selective advertisement, may be billed to the respective advertisers. Further, the transmitter terminal 10 and the receiver terminal 20 may receive reward credit or points for receiving advertisement and/or transmitting advertisement to other terminals. The communication expenses may be billed or credited in consideration of at least one of the number of times and the duration of time the advertisement is displayed on the transmitter terminal 10 and the receiver terminal 20. In addition, the billing operation of the transmitter terminal 10 and the receiver terminal 20 may be performed in various ways, including, but not limited to, offering reward points or credits for the advertisement provided to the transmitter terminal 10 and the receiver terminal 20, providing a permit to use communication operator's or the advertiser's shopping malls with the reward points, providing is coupons for a pertinent advertiser's products, giving a discount for add-on operation service, providing a discount of communication expenses, offering paid-for applications, and so on.

Although not illustrated, the receiver terminal 20 may be exposed to an advertisement associated with the transmitter terminal 10 even if the receiver terminal 20 may not provide a consent control signal. For example, the receiver terminal 20 may receive such advertisement even without providing the consent control signal if the transmitter terminal 10 is registered as a contact in the receiver terminal 20. Similarly, the receiver terminal 20 may receive advertisements of the transmitter terminal 10 without providing the consent control signal, if the user of the transmitter terminal 10 is designated in a specific group or has a specific designation.

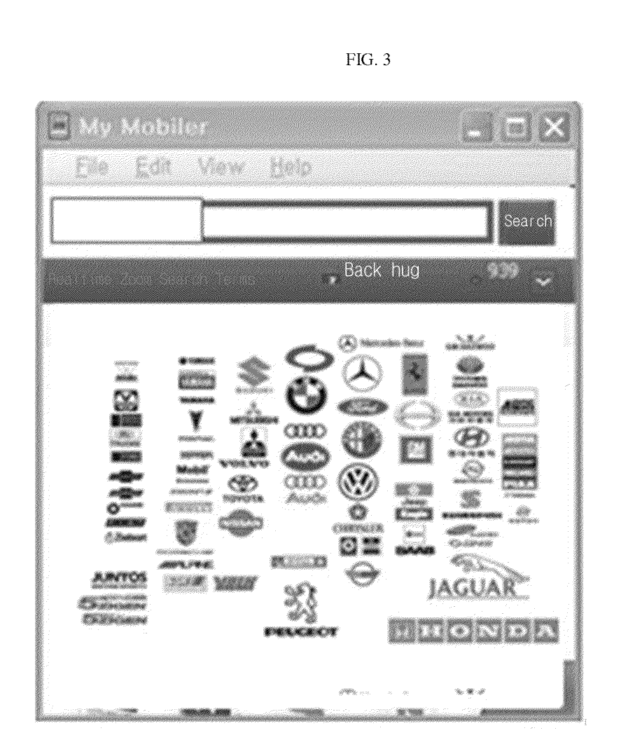

FIG. 3 is a diagram illustrating an advertisement selection screen in the advertising system of FIG. 1.

Referring to FIG. 3, in the advertising system 100, the user of the transmitter terminal 10 may connect to an internet web page to select an advertisement to be displayed on the transmitter terminal 10 and possibly, the receiver terminal 20. The advertisement may be displayed in various forms including, but not limited to, a company logo, a product trademark, an advertisement capture screen, and an advertising motion picture. The transmitter terminal 10 may select at least one of the forms of the advertisement. In addition, as will be described below, the transmitter terminal 10 may display the advertisement on a directory of contacts. More specifically, the advertisement may be set to be displayed in front of at least one of the names in the directory of contacts. In addition, the transmitter terminal 10 may display the advertisement on a screen if a ring tone is displayed.

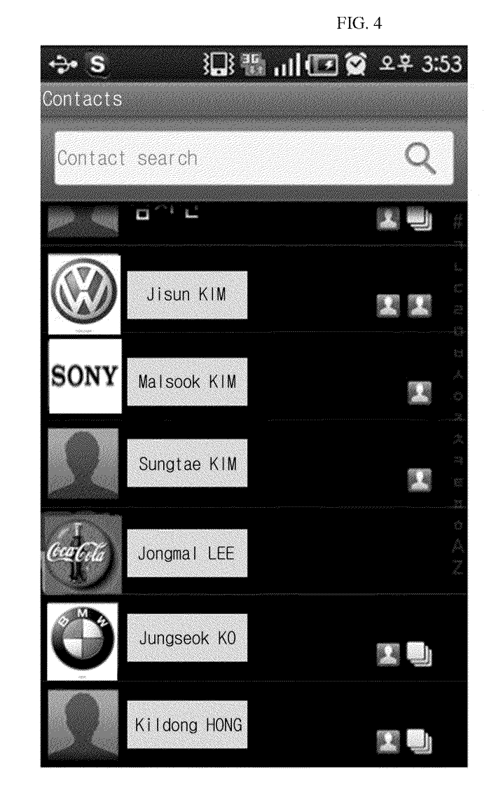

FIG. 4 is a diagram illustrating an advertisement displayed on a transmitter is terminal in the advertising system of FIG. 1.

Referring to FIG. 4, in the advertising system 100, the advertisement selected by the transmitter terminal 10 is displayed with the directory of contacts of the transmitter terminal 10. In addition, the transmitter terminal 10 may display different advertisements in front of names of the respective contacts in the directory. Therefore, selective advertisement is displayed on the transmitter terminal 10 to be exposed to the user of the transmitter terminal 10. The user of the transmitter terminal 10 may be exposed to the advertisement in the course of searching for contact information from the transmitter terminal 10 and the advertisement may be recognized by the user of the transmitter terminal 10.

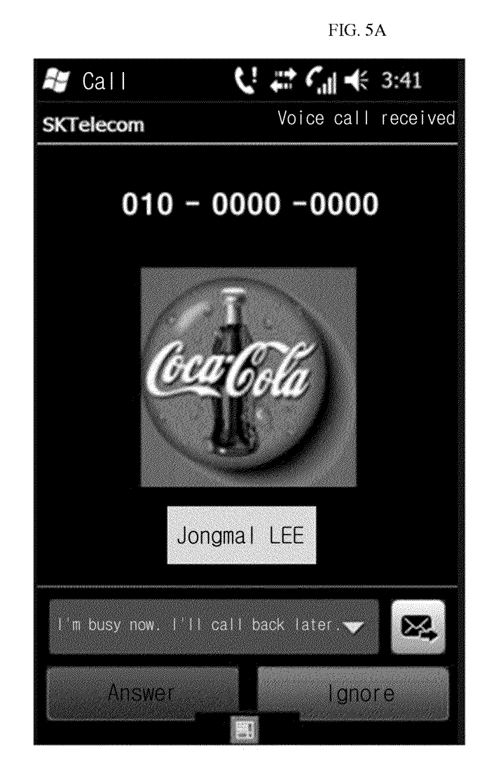

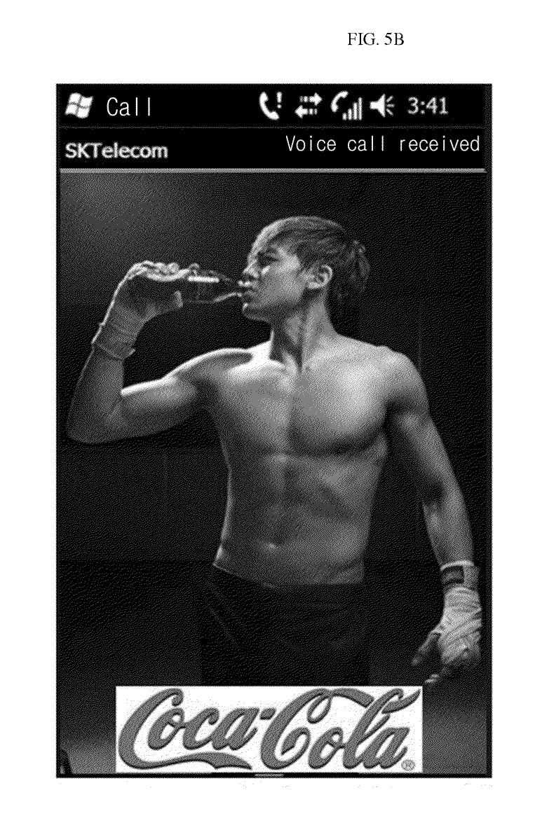

FIG. 5A and FIG. 5B illustrate an advertisement displayed on a receiver terminal in an advertising system according to an exemplary embodiment of the present invention.

Referring first to FIG. 5A, if a call from the transmitter terminal 10 is received in the receiver terminal 20, the advertising system 100 exposes the advertisement selected by the transmitter terminal 10 on a call waiting screen of the receiver terminal 20. In an example, the receiver terminal 20 may be requested to provide consent in receiving the advertisement associated with at least the transmitter terminal 10 before receiving the advertisement. The advertisement is displayed in the form of a product trademark, but not limited thereto. The advertisement may be displayed in various forms, including a company logo, an advertisement capture screen, an advertising motion picture, and so on. The advertisement exposed to the receiver terminal 20 may be displayed until calling with the transmitter terminal 10 is performed or refused. Alternatively, the advertisement may be exposed to the receiver for a reference period of time. Therefore, if a call is attempted or transmitted from the transmitter terminal 10 to the receiver terminal 20, the advertisement may be exposed to the receiver terminal 20.

Referring to FIG. 5B, in the advertising system 100 the advertisement is displayed on the receiver terminal 20 while the receiver terminal 20 performs a calling operation. Therefore, the user of the receiver terminal 20 is also exposed to the advertisement during the calling operation as well as the call receiving operation. Similar steps may be provided for text messaging as well.

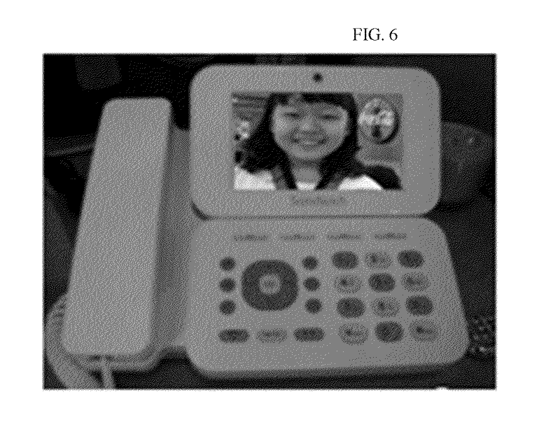

FIG. 6 illustrates an advertisement displayed on a receiver terminal during a video call in the advertising system of FIG. 5A.

Referring to FIG. 6, in the advertising system 100, the advertisement is displayed on a receiver terminal 20 during a video call performed with the transmitter terminal 10. The advertisement may be created on a portion of an edge area other than a central area in which a transmitter's face is displayed on the receiver terminal 20. Since the receiver terminal 20 is exposed to the advertisement while performing the video call with the transmitter terminal 10, exposure to the respective advertisement can be increased.

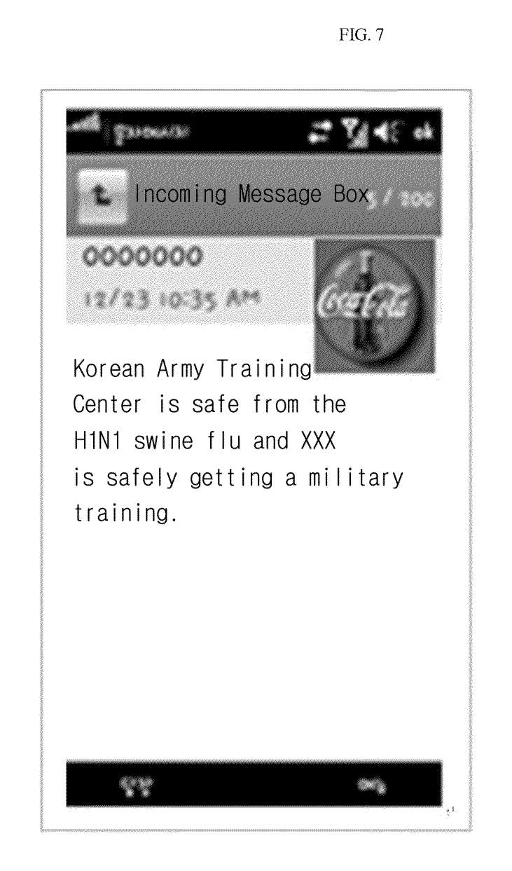

FIG. 7 illustrates an advertisement displayed on a receiver terminal in response to a text message received in an advertising system according to an exemplary embodiment of the present invention.

Referring to FIG. 7, in the advertising system 100, a text message is transmitted to the receiver terminal 20. If the text message is transmitted to the receiver terminal 20, the receiver terminal 20 displays the advertisement together with the text message. The respective advertisement may be positioned on a portion other than a display area of the text message. However, it is not limited thereto. For example, the respective advertisement may be embedded in the text message itself. In addition, the advertisement may be positioned at a right top of the text message, but the present invention does not limit the position of the text message to that is illustrated herein. Rather, the advertisement may be positioned at various areas where or near where the text message is displayed

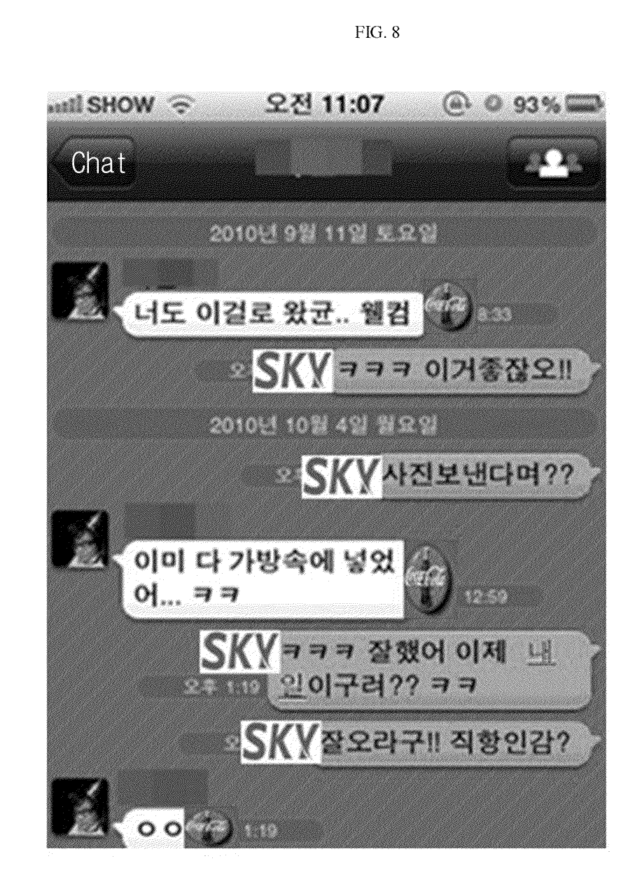

FIG. 8 illustrates that an advertisement displayed in response to execution of a text message transmitting application in an advertising system according to an exemplary embodiment of the present invention.

Referring to FIG. 8, in the advertising system 100, an advertisement is displayed if text messages are exchanged between the transmitter terminal 10 and the receiver terminal 20 by executing a text transmission application. The displayed advertisement may include some or all of advertisements selected by the transmitter terminal 10. In addition, the advertisement displayed on the transmitter terminal 10 may be an advertisement selected by the transmitter terminal 10 and the advertisement displayed on the receiver terminal 20 may be an advertisement selected by the receiver terminal 20.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An advertising system, comprising:
a first terminal to transmit an advertisement receipt consent signal; and
an advertising server to store a list of advertisements, to provide one or more advertisements from the list of advertisements to be selected, and to provide a selected advertisement to the first terminal.

2. The advertising system of claim 1, further comprising:
a second terminal to receive the advertisement provided to the first terminal, if the second terminal transmits a consent control signal.

3. The advertising system of claim 1, further comprising:
a second terminal to receive the advertisement provided to the first terminal, if the second terminal receives at least one of a call signal or a text from the first terminal.

4. The advertising system of claim 2, further comprising:
a communication server to transmit an inquiry to the second terminal inquiring whether to display the advertisement provided to the first terminal on the second terminal.

5. The advertising system of claim 4, wherein the advertising server stores the consent control signal and the communication server prevents transmission of the inquiry to the second terminal according to the consent control signal.

6. The advertising system of claim 1, wherein the first terminal displays the advertisement on at least one of a directory of contacts, a call screen, and a text message.

7. The advertising system of claim 1, wherein the selected advertisement is selected from the list of advertisements using a computing device.

8. The advertising system of claim 1, wherein the selected advertisement is selected from the list of advertisements using the first terminal.

9. The advertising system of claim 1, wherein
the selected advertisement comprises at least one of a company logo, a product trademark, an advertisement capture screen, an advertising motion picture, a dial tone, and a ring tone.

10. A method for selectively providing an advertisement, comprising:
transmitting an advertisement receipt consent signal from a first terminal;
selecting an advertisement from a list of advertisements; and
providing the selected advertisement to the first terminal.

11. The method of claim 10, further comprising:
receiving the advertisement provided to the first terminal by a second terminal, if the second terminal transmits a consent control signal.

12. The method of claim 10, further comprising:
receiving the advertisement provided to the first terminal by a second terminal, if the second terminal receives at least one of a call signal or a text from the first terminal.

13. The method of claim 11, further comprising:
transmitting an inquiry to the second terminal inquiring whether to display the advertisement provided to the first terminal on the second terminal.

14. The method of claim 13, further comprising:
storing the consent control signal; and
preventing transmission of the inquiry to the second terminal according to the consent control signal.

15. The method of claim 10, further comprising:
displaying the advertisement on at least one of a directory of contacts, a call screen, and a text message of the first terminal.

16. The method of claim 11, further comprising:
billing communication expense associated with the advertisement to a corresponding advertiser.

17. The method of claim 16, wherein the communication expense is billed in consideration of at least a number of times and duration of the advertisement displayed on at least one of the first terminal and the second terminal.

18. The method of claim 10, wherein the selected advertisement is selected from the list of advertisements using a computing device.

19. The method of claim 10, wherein the selected advertisement is selected from the list of advertisements using the first terminal.

20. An advertising system, comprising:
a first terminal to transmit a first advertisement receipt consent signal;
an advertising server to store a list of advertisements selectable by the first terminal, to associate a selected advertisement with the first terminal, and to provide the selected advertisement to the first terminal;
a communication server to transmit an inquiry to a second terminal inquiring whether to display the selected advertisement on the second terminal; and
the second terminal to receive the selected advertisement if the second terminal transmits a consent control signal in response to the inquiry.

21. A terminal, comprising:
a communication unit to receive a list of advertisements including at least one selected advertisement; and
a display unit to receive the at least one selected advertisement from a server, and to display the at least one selected advertisement.
